(19) United States
(12) Patent Application Publication
(10) Pub. No.: US 2022/0224170 A1
(43) Pub. Date: Jul. 14, 2022

(54) BEAM PROFILE MONITOR

(71) Applicant: LASERMOTIVE, INC., Kent, WA (US)

(72) Inventors: Thomas J. NUGENT, Jr., Bellevue, WA (US); Thomas W. BASHFORD, Renton, WA (US); David BASHFORD, Kent, WA (US)

(21) Appl. No.: 17/613,028

(22) PCT Filed: May 21, 2020
(86) PCT No.: PCT/US2020/034095

§ 371 Date: Nov. 19, 2021

Related U.S. Application Data
(60) Provisional application No. 62/851,029, filed on May 21, 2019.

(51) Int. Cl. H02J 50/90; H02J 50/30

(52) U.S. Cl. CPC H02J 50/90; H02J 50/30

(57) ABSTRACT

A method of monitoring a location of a power beam includes monitoring an electrical property of PV cells or subgroups of PV cells in a PV cell array and using the monitored electrical property to determine a location of the power beam. The determined location may be compared to a target location on the PV cell array and used to steer the power beam closer to the target location.

### CROSS-REFERENCE TO RELATED APPLICATION

This application claims benefit under 35 U.S.C. § 119(e) of U.S. Provisional Patent Application No. 62/851,029, filed May 21, 2019, which is incorporated herein by reference to the extent not inconsistent herewith.

### BACKGROUND

Some aspects of technologies and related art that may be useful in understanding the background of the present disclosure are described in the following publications:
Published U.S. Patent application 2014/0318620 A1 of Kare et al., which describes a device for converting electromagnetic radiation into electricity;
U.S. Pat. No. 10,374,466 of Olsson et al., which describes an energy efficient vehicle with integrated power beaming;
Published U.S. Patent Application 2019/0064353 A1 of Nugent et al., which describes a remote power safety system;
U.S. Pat. No. 10,488,549 of Kare et al., which describes a system for locating power receivers;
U.S. Pat. No. 10,634,813 of Kare et al., which describes a multi-layered safety system;
Published U.S. Patent Application 2018/0136335 A1 of Kare et al., which describes a diffusion safety system; and
Published U.S. Patent Application 2018/0136364 A1 of Kare et al., which describes a light curtain safety system.

Power beaming is an emerging method of transmitting power to places where it is difficult or inconvenient to access wires, by transmitting a beam of electromagnetic energy to a specially designed receiver which converts it to electricity. Power beaming systems may be free-space (where a beam is sent through atmosphere, vacuum, liquid, or other non-optically-designed media), or power-over-fiber (“PoF”), where the power is transmitted over an optical fiber. The latter may share certain disadvantages with wires in some circumstances, but may also offer increased transmission efficiency, electrical isolation, and/or safety. Free-space power beaming may be more flexible, but may also offer more challenges for accurate targeting of receivers and avoiding hazards such as reflections and objects intruding on the power beam.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventors' approach to the particular problem, which in and of itself may also be inventive.

### SUMMARY

A power beam will generally have some amount of inhomogeneity in its intensity profile when it impinges on a power receiver, and its shape may also not perfectly match a receiver's geometry. Knowing the approximate beam profile on a power converter array, and knowing its position relative to the array, can be useful for goals such as feedback in beam steering, optimizing power extraction, and safety sensing. The Power Beam Monitor described herein determines an approximate beam profile by monitoring light response of individual power converters (or groups of power converters) and/or by monitoring photodiodes or the like positioned to monitor light falling on the power converter array.

In one aspect, a method of determining a power beam position on an array includes directing a power beam at an array of power converters (e.g., photovoltaic (PV) cells) including one or more subgroups of power converters, each subgroup having a position, determining a response to the power beam for each subgroup of the one or more subgroups, and combining the determined response of each subgroup and the position of each subgroup to calculate a nominal center of the power beam. The response may be output current, output voltage, output power, or power converter temperature. The array may include a target location, and the method may further include steering the power beam in a direction that moves the determined nominal location closer to the target location, in which case the method may further include communicating the determined location and/or a desired direction of beam movement (e.g., a direction from the determined nominal center to the target location) to a beam steering mechanism. The method may include communicating a determined response of each subgroup to a source location of the power beam. Calculating a nominal location may include determining weighted centroid of the response, simple centroid of the response, extent of the response, second moment of the response, or location of peak intensity of the response.

In another aspect, a power beaming control method includes monitoring at least one response parameter (e.g., output current, output voltage, output power, or temperature) for each member of a plurality of subgroups of power converters (e.g., PV cells) on a receiver, using the monitored response parameter to determine a location of a power beam on the receiver, and transmitting an instruction to a beam steering system in response to the monitored response parameter. The instruction may include a direction and/or a distance to move the laser power beam, the determined location of the laser power beam, and/or the monitored response parameter for each of the plurality of subgroups of power converters on the receiver.

In another aspect, a power beaming system includes a power transmitter configured to transmit a power beam; a power receiver including a plurality of power converter structures, the power converter structures configured to convert the transmitted power beam to electrical energy; a sensor configured to monitor a response of each of one or more subgroups of the power converter structures (e.g., output current, output voltage, output power, or power receiver temperature); a processor configured to use the monitored response to determine a nominal location of the power beam on the power receiver; and a communication transmitter configured to communicate an indicator of the nominal location to the power transmitter. If the processor is co-located with the receiver, the indicator may be a nominal location of the power beam, a direction from a nominal location of the power beam to a target location, or a distance from a nominal location of the power beam to a target location. If the processor is co-located with the power transmitter, the indication may include monitored response data from the sensor. Determining a nominal location of the power beam may include determining weighted centroid of the response, simple centroid of the response, extent of the response, second moment of the response, or location of peak intensity of the response. The method may further include responding to a communication of the indicator of the nominal location by changing a direction of the power beam.

In another aspect, a method of determining an orientation of a power receiver having at least three beacons thereon includes determining a first average position of the beacons by monitoring an electromagnetic frequency emitted by the beacons, signaling the power receiver to disable a selected one or more of the beacons, determining a second average position of the plurality of beacons by monitoring the electromagnetic frequency emitted by the beacons after the power receiver has disabled the selected one or more beacons, and calculating an orientation of the power receiver by comparing the first average position with the second average position, wherein the calculated orientation will have the second average position further away from the selected one or more beacons than the first average position.

### BRIEF DESCRIPTION OF THE DRAWING

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Featured of the depicted embodiments that are not directly relevant to the novel elements discussed may be omitted for clarity. One or more embodiments are described hereinafter with reference to the accompanying drawings as follows.

FIG. 1 is a diagram of a laser power beaming system.

FIG. 2 is a diagram of a power receiver.

FIG. 3 is a flow chart of a method of operating a power beaming system.

FIG. 4 is a diagram of a power receiver with cells divided into five subgroups.

### DETAILED DESCRIPTION

A more particular description of certain embodiments of a Power Beam Monitor may be had by reference to the embodiments described below, and those shown in the drawings that form a part of this specification, in which like numerals represent like objects. It is understood that the description and drawings represent example implementations and are not to be understood as limiting. Drawings are not drawn to scale unless otherwise noted herein.

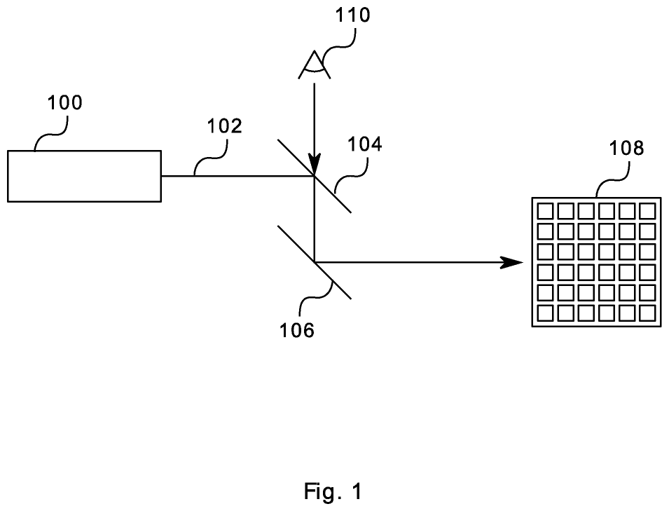

FIG. 1 is a schematic diagram of a laser power beaming system. Laser 100 directs a laser beam 102 toward a combining mirror 104, such as a dichroic mirror, which redirects the beam to a steering mirror 106. Steering mirror 106 directs the beam to power receiver 108. It will be understood that laser 100 and mirrors 104, 106 may include other elements, such as beam shapers, guard beams, beam integrators, or other appropriate accessory elements, that have been omitted from FIG. 1 for the sake of clarity. For example, steering mirror 106 may actually include multiple mirrors designed for making coarse and fine steering adjustments. Mirrors 104, 106 may also be replaced by other elements such as phased arrays, diffraction gratings, or other components appropriate to the power and frequency of the system. It will be understood that while FIG. 1 shows a laser power beaming system, the methods and systems described herein are also applicable to other types of power beaming, such as microwave, millimeter-wave, and acoustic power beaming.

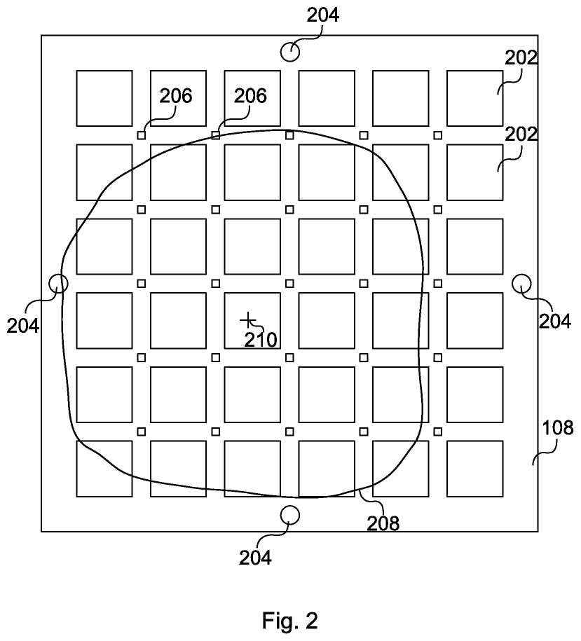

FIG. 2 is a schematic diagram of power receiver 108. The receiver may include an array of PV cells 202. While the illustrated array is rectilinear, it will be understood that in some implementations, PV cells may have varied sizes, shapes, and positions. The receiver may also include optional beacons 204 and optional photodiodes 206. (To improve clarity of FIG. 2, not every PV cell 202 or photodiode 206 has been labeled.) Beacons 204 may be used for determining a coordinate transformation for receiver 108 as further described below. Photodiodes 206 may be used for determining beam positioning as further described below. Also shown is an example laser spot 208. It will be understood that laser spot 208 may not have sharply defined edges as shown in FIG. 2, but instead may have another beam profile, such as one in which intensity may be greater at the center of the beam and may taper away at the edges, or one with a greater intensity “ring” at the periphery which may taper both toward the edges and toward the center.

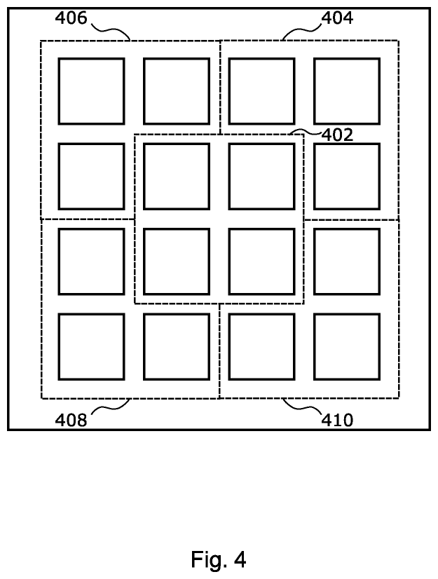

In order to determine a placement of the beam on receiver 108, receiver 108 may incorporate electronic systems that monitor an intensity of power beam 102 by any of a variety of means. In one implementation, intensity may be inferred by monitoring a current, voltage, or power produced by PV cells 202. The monitored property may be produced by the main beam, or by a less intense or different frequency beam, for example one that is used for aligning the system during startup or for checking safety of the system before applying full power. The less intense beam may be used for aiming to avoid misdirecting an intense power beam onto electronics that may not be expecting to receive a high light flux, or to avoid unexpected reflections or misalignment that could compromise eye safety. The current, voltage, or power may be monitored for each PV cell 202 individually, or cells may be monitored as virtual groups which each report a single aggregate current, voltage, or power, as further discussed below in connection with FIG. 4. In some implementations, such virtual groups may conveniently correspond to groups that are wired together (in series or in parallel), but the groups need not have any particular wiring architecture.

At typical operating loads, current, voltage, and power output of a PV cell will usually all monotonically increase as the amount of light impinging on the cell increases, sometimes with a high slope (sensitive to changes in intensity) and sometimes with a relatively slight response, depending on the amount of power and on other factors such as cell temperature. Voltage, in particular, is relatively insensitive to light intensity in most parts of the operating range, which may preferably be relatively close to a maximum power point. In implementations where the PV cell outputs are used for beam position monitoring, it may be most accurate to use the parameter that has the strongest response to light intensity in the expected range, which will often, but not always, be the current. Because power is equal to the product of the voltage and the current, in other implementations it may be convenient to monitor power for cells or groups of cells. While the description below will refer to the current when describing the Power Beam Monitor, it will be understood that in some implementations, power or voltage could instead be monitored to achieve similar results.

By measuring the current generated by each PV cell 202 or group of PV cells, the system can determine a nominal location 210 (e.g., a center) for the power beam, such as a simple centroid, a weighted centroid (for example, the center of intensity), an intensity peak, or other known methods for identifying centers of distributions. In some implementations, the system may also determine a range of the beam width, such as extents, second moment, or other properties of the beam intensity distribution. These determination steps may be performed by a processor located at the receiver, at the transmitter, or elsewhere in the system. Determining the position of the nominal location 210 may involve simply determining whether each cell is above or below a threshold current and averaging the positions of those which are above the threshold, or it may include a more complicated averaging process that weights positions by relative value of the measured current, and possibly by size of the PV cells or groups. In some implementations, especially but not only when operating in a low-power range, rather than simply measuring the current, voltage, or power generated by a cell or group of cells, it may be preferable to vary the light intensity or the receiver load and use the change in monitored parameter, rather than its absolute value, to determine a beam location. Other parameters that could affect PV cell response, such as temperature of the cell, may also be monitored, for example so that their effects can be compensated for. In other implementations, especially but not necessarily at high power, cell temperature could be monitored as a measure of beam position, without monitoring an electrical property of the PV cells.

In other implementations, receiver 108 may use photodiodes 206 and/or photoresistors (not shown) to identify a nominal location of power beam 102. Similar to monitoring current as discussed above, the processor may simply average the positions of all photodiodes/photoresistors that are illuminated by the power beam to calculate a nominal location 210, or it may use a weighted average that takes into account component spacing and light intensity as sensed by each component. In implementations that have photodiodes or photoresistors placed in spaces between PV cells, it may be preferred to split the power beam so that most of the beam impinges on the PV cells, rather than some of the beam impinging between them, as more fully described in commonly owned provisional patent application No. 62/851,037, filed May 21, 2019 and entitled “Remote Power Beam-Splitting,” and commonly owned PCT application entitled “Remote Power Beam-Splitting” being filed on even date herewith, with attorney docket no. P016.WO, both of which are incorporated by reference herein to the extent not inconsistent herewith. In order to use the methods described herein to find a location of the power beam, it is preferred that some amount of the light originating from the power beam reach photodiodes 206, but it is possible that this will be primarily scattered and/or reflected light.

Once a location 210 of the light beam has been determined, that location may be fed back to steering mirror 106 to adjust the laser position, for example by radio frequency (RF) or optical transmission, either as its own dedicated signal or part of a telemetry stream. This transmission may, for example, be done manually as part of an initial laser setup, automatically at the start of power beaming, or dynamically during the power beaming process. The latter option may be preferable during a power beaming session where laser 100 or receiver 108 may move or where ambient conditions may change (e.g., due to thermal expansion of an optical element or differential refraction due to air turbulence), while the former two options may be adequate for systems where a path of the laser beam is expected to stay fixed. For example, as shown in FIG. 2, location 210 of the light beam is below and to the left of the center of receiver 108. The steering mirror 106 could be adjusted to redirect the power beam 102 up and to the right so that it is directed as close as possible to the center of the array. Of course, in some implementations, the target location for the beam might not be the geometric center of receiver 108, but appropriate signals may be sent to steering mirror 106 to bring the beam as close as possible to the target, wherever it may be.

In some implementations, the target location might move in a dynamic way, for example to minimize overheating of certain PV cells in the array. In accordance with general engineering principles, those of ordinary skill in the art will understand that in a dynamic system, the recurrence and power of feedback signals should be selected to avoid either overshooting or undershooting beam position adjustments. The data gathered describing beam intensity may also be used by an adaptive optics system at the transmitter to shape the outgoing beam to change the intensity profile at the receiver. For example, the beam might be shaped to produce a more uniform profile at the receiver, or to reduce the intensity at a PV cell that may be performing poorly, or to cover a larger or smaller area of the receiver.

As shown in FIG. 2, receiver 108 also includes four beacons 204. These beacons may be used for determining the positioning of receiver 108 relative to laser 100. As shown in FIG. 1, sensor 110 is positioned to sense along a line that is approximately collinear with laser beam 102 after the beam has reflected from combining mirror 104. If sensor 110 is not perfectly aligned with laser beam 102 (or if the optical path through the atmosphere is slightly different for the beacon wavelength as compared to the power beam wavelength), any offset can generally be compensated for as long as the offset and distance are known. Sensor 110 may be, for example, a camera, a position sensing device (PSD), or a photodiode. In implementations other than that illustrated in FIG. 1, other equivalent methods for sensing the locations of beacons 204 may also be used. Sensor 110 “sees” beacons 204 at the edges of receiver 108 and uses their positions to adjust steering mirror 106 to center laser beam 102 on receiver 108 and/or to adjust the width of beam 102 to use receiver 108 more efficiently. Beacons 204 need not be uniformly distributed around the receiver as shown in FIG. 2; a machine vision system viewing beacons with a deliberate asymmetry can determine a full set of degrees of freedom relative to sensor 110. In some implementations, sensor 110 can detect only an average position of the four illustrated beacons, while in other implementations, it may be able to “see” each beacon separately. Orientation of receiver 108 relative to steering mirror 106 may be determined by turning off one or more beacons and looking at either their average position or at the individual positions of the remaining one or more beacons. In implementations where sensor 110 cannot distinguish individual beacons, the distance that the average position of the beacons moves when one beacon is temporarily turned off can nevertheless be used to infer distance from the transmitter to receiver 108 as well as orientation. These data allow the power beaming system to determine a coordinate transformation that corresponds to the relative positions of steering mirror 106 and receiver 108, which can be used for the feedback signals described above.

In other implementations, rather than separate beacons, light emitters such as the “light curtain” emitters described in commonly owned U.S. Patent Application Publication Nos. 2018/0136364, 2019/0064353, and 2018/0131449, which are incorporated by reference herein to the extent not inconsistent herewith, may be used to perform the same function. In still other implementations, beacons may not be powered at all, but may simply be fiducial marks on the surface, reflectors, or retroreflectors, which may be asymmetric in order to allow the system to determine rotation as well as distance. Of course, combinations of the above systems may also be used, such as using “light curtain” emitters for determining distance and a single beacon for determining orientation, or using beacons for an initial determination of a coordinate transformation and “light curtain” emitters for dynamic adjustment during operation.

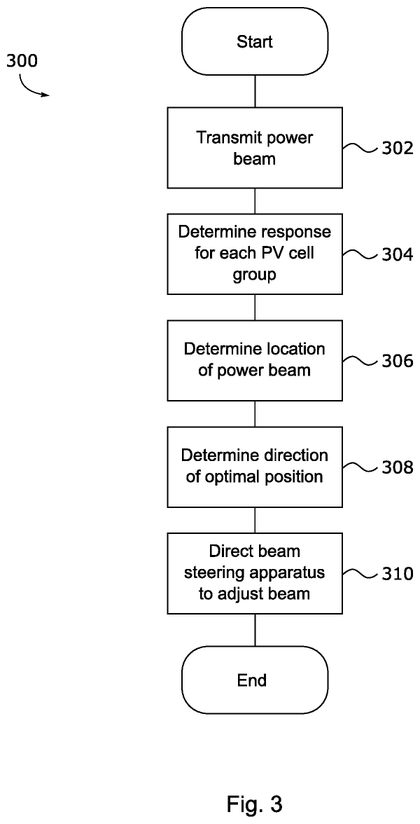

FIG. 3 is a flow chart 300 showing steps of operating a power beaming system such as the one described above. When the method begins, the power beaming system first transmits a power beam toward a receiver (step 302) and determines a response for each subgroup of PV cells 202 (step 304). In some implementations, each PV cell is its own subgroup, while in other implementations, subgroups may include multiple cells. When subgroups include multiple cells, they may be physically adjacent, or subgroups may include cells that are physically spaced apart from one another but wired together (e.g., in series or in parallel), or cells may be grouped in any other convenient arrangement. In some implementations, any single PV cell 202 may be in only one subgroup, while in other implementations, a PV cell 202 may be in multiple distinct subgroups.

As discussed above, the response determined in step 304 may be any measurable response to laser light being directed onto PV cells 202 of a subgroup. For example, the measured response may be current, voltage, power, temperature, or rate of change of any of the above parameters. The system combines the monitored response with a known position for each subgroup to infer relative light intensity at each position (step 304).

It will be understood that in array subgroups having different areas or different PV cells, the monitored response may need to be adjusted accordingly. For example, consider an array divided into five subgroups of PV cells as shown in FIG. 4. Group 402 at the center includes four central PV cells, while groups 404, 406, 408, 410 at the four corners each include three peripheral PV cells. If the illustrated cells all have an identical current response to illumination, and the illustrated groups each include cells wired in parallel, then the current in group 402 is expected to be 4/3 that of group 404, because group 402 includes 4/3 as many cells. The division shown in FIG. 4 is of course intended to be a nonlimiting example, and many wiring arrangements are contemplated for use with the instant systems and methods. In other implementations, PV cells 202 may not all be identical, and thus may have different responses to the same incident light. As long as the response curve is known for each subgroup, the processor may do the necessary conversions to determine the relative light intensity for each subgroup.

Once the system has determined a response to incident light for each subgroup (step 304), adjusting for subgroup areas and/or individual cell responses as described above if appropriate, it uses the responses and their locations to determine a location of the power beam (step 306). For example, the system may determine a simple centroid of the response across the cells, or it may use any of the foregoing methods for identifying the beam location. Optionally, after the beam position has been located in step 308, the system may further determine that the power beam is not optimally positioned, and may direct the beam steering mechanism to adjust it (step 310). For example, the receiver may determine (using a processor) that the power beam needs to move in a given direction (and optionally also a distance to move), and may transmit the desired adjustment to the transmitter as described above. In other implementations, the receiver may transmit raw or processed response data to the transmitter or elsewhere in the system, and beam adjustment may be calculated and applied there. After the optional position adjusting step has been completed, the system may return to the beginning of the flow chart to continue measuring for further adjustment. In other implementations, the position adjustment may be applied only once, and the method may terminate.

While the foregoing has described what are considered to the best mode and/or other examples, it is understood that various modifications may be made therein, and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The scope of protection is limited solely by the claims that now follow. That scope is intended to be as broad as is consistent with the ordinary meanings of the language that is used in the claims when interpreted in light of this specification and the prosecution history that follows and to encompass all structural and functional equivalents. Notwithstanding, none of the claims are intended to embrace subject matter that fails to satisfy the requirements of Sections 101, 102, or 103 of the Patent Act, nor should they be interpreted in such a way. Any unintended embracement of such subject matter is hereby disclaimed.

Except as stated in the previous paragraph, nothing that has been stated or illustrated is intended or should be interpreted to cause a dedication of any component, step, feature, objects, benefit, advantage, or equivalent to the public, regardless of whether it is or is not recited in the claims.

Unless defined otherwise, the technical and scientific terms used herein have the same meaning as commonly understood by one of ordinary skill in the relevant art. Although any methods and materials similar or equivalent to those described herein may also be used in the practice or testing of the present claims, a necessarily limited number of the exemplary methods and materials are described herein. Relational terms such as first and second and the like may be used solely to distinguish one entity from another without necessarily implying any relationship or order between such entities. The terms “comprise” and “include,” in all their grammatical forms, are intended to cover a non-exclusive inclusion, so that a process, method, article, apparatus, or composition of matter that comprises or includes a list of elements may also comprise or include other elements not expressly listed. The term “or,” without additional explanation, is to be interpreted inclusively as “and/or.” An element preceded by “a” or “an” does not, without further constraints, preclude the existence of additional identical or similar elements.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features may be grouped together in various examples for the purpose of clarity of explanation. This method of disclosure is not to be interpreted as reflecting an intention that the claims require more features than are expressly recited in each claim. Furthermore, features from one example may be freely included in another, or substituted for one another, without departing from the overall scope and spirit of the instant application.

1. A method of determining a power beam position on an array, comprising:
directing a power beam at an array of power converters including one or more subgroups of power converters, each subgroup having a position;
determining a response to the power beam for each subgroup of the one or more subgroups; and
combining the determined response of each subgroup and the position of each subgroup to calculate a nominal location of the power beam.

2. The method of claim 1, wherein the power converters are photovoltaic (PV) cells.

3. The method of claim 1, wherein the response is selected from the group consisting of output current, output voltage, output power, and power converter temperature.

4. The method of claim 1, wherein the array includes a target location, and wherein the method further includes steering the power beam in a direction that moves the determined nominal location closer to the target location.

5. The method of claim 4, further comprising communicating the determined location to a beam steering mechanism.

6. The method of claim 4, further comprising communicating a desired direction of beam movement to a beam steering mechanism.

7. The method of claim 6, wherein the desired direction is a direction from the calculated nominal location of the power beam to the target location.

8. The method of claim 1, further comprising communicating the determined response of each subgroup to a source location of the power beam.

9. The method of claim 1, wherein calculating a nominal location of the power beam includes determining at least one of the following parameters:
weighted centroid of the response;
simple centroid of the response;
extent of the response;
second moment of the response; or
location of peak intensity of the response.

10. A power beaming control method, comprising:
monitoring at least one response parameter for each member of a plurality of subgroups of power converters on a receiver;
using the monitored response parameter to determine a location of a power beam on the receiver; and
transmitting an instruction to a beam steering system in response to the monitored response parameter.

11. The power beaming control method of claim 10, wherein the power converters are photovoltaic (PV) cells.

12. The power beaming control method of claim 10, wherein the monitored response parameter is selected from the group consisting of output current, output voltage, output power, or power converter temperature.

13. The power beaming control method of claim 10, wherein the instruction includes a direction to move the power beam.

14. The power beaming control method of claim 13, wherein the instruction includes a distance to move the power beam.

15. The power beaming control method of claim 10, wherein the instruction includes the determined location of the power beam.

16. The power beaming control method of claim 10, wherein the instruction includes the monitored response parameter for each of the plurality of subgroups of power converters on the receiver.

17. A power beaming system, comprising:
a power transmitter configured to transmit a power beam;
a power receiver including a plurality of power converter structures, the power converter structures configured to convert the transmitted power beam to electrical energy;
a sensor configured to monitor a response of each of one or more subgroups of the power converter structures;
a processor configured to use the monitored response to determine a nominal location of the power beam on the power receiver; and
a communication transmitter configured to communicate an indicator of the nominal location to the power transmitter.

18. The power beaming system of claim 17, wherein the processor is co-located with the power receiver, and wherein the indicator is selected from the group consisting of:
a nominal location of the power beam;
a direction from a nominal location of the power beam to a target location; and
a distance from a nominal location of the power beam to a target location.

19. The power beaming system of claim 17, wherein the processor is co-located with the power transmitter, and wherein the indicator includes monitored response data from the sensor.

20. The power beaming system of claim 18 or 19, wherein the power transmitter is configured to respond to the communication of the indicator of the nominal location by steering the power beam toward a target location.

21. The power beaming system of claim 17, wherein the processor is configured to use the monitored response to determine the nominal location of the power beam by determining at least one member of the group consisting of:
weighted centroid of the response;
simple centroid of the response;
extent of the response;
second moment of the response; or
location of peak intensity of the response.

22. The power beaming system of claim 17, wherein the monitored response is selected from the group consisting of output current, output voltage, output power, and power receiver temperature.

23. The power beaming system of claim 17, wherein the power transmitter is configured to respond to the communication of the indicator of the nominal location by changing a direction of the power beam.

24. A method of determining an orientation of a power receiver having at least three beacons thereon, the method comprising:
determining a first average position of the beacons by monitoring an electromagnetic frequency emitted by the beacons;
signaling the power receiver to disable a selected one or more of the beacons;
determining a second average position of the plurality of beacons by monitoring the electromagnetic frequency emitted by the beacons after the power receiver has disabled the selected one or more beacons; and
calculating an orientation of the power receiver by comparing the first average position with the second average position, wherein the calculated orientation will have the second average position further away from the selected one or more beacons than the first average position.
